(19) United States
(12) Patent Application Publication
(10) Pub. No.: US 2024/0026125 A1
(43) Pub. Date: Jan. 25, 2024

(54) COMPOSITION COMPRISING AT LEAST ONE ORGANIC PEROXIDE AND AT LEAST ONE SULFUR-CONTAINING COMPOUND FOR CROSSLINKING POLYMERS IN THE PRESENCE OF OXYGEN

(71) Applicant: ARKEMA FRANCE, COLOMBES (FR)

(72) Inventor: Alfredo DEFRANCISCI, PIERRE-BÉNITE (FR)

(21) Appl. No.: 17/998,933

(22) PCT Filed: Oct. 8, 2021
(86) PCT No.: PCT/EP2021/077944

§ 371 Date: Nov. 16, 2022

(30) Foreign Application Priority Data
Oct. 9, 2020 (FR) FR2010360

(51) Int. Cl. C08K 5/14; C08K 5/5398; C08K 3/06; C08K 3/04; C08L 23/16

(52) U.S. Cl. CPC C08K 5/14; C08K 5/5398; C08K 3/06; C08K 3/04; C08L 23/16; C08L 2312/00

(57) ABSTRACT

The present invention deals with a composition comprising at least one organic peroxide, at least one sulfur-containing compound chosen among the group consisting of dialkyl phosphorodithioic acid and salts thereof, and optionally sulfur under its free form.

### FIELD OF THE INVENTION

The present invention deals with a composition comprising at least one organic peroxide and at least one sulfur-containing compound chosen among the group consisting of dialkyl phosphorodithioic acid and salts thereof.

The invention also relates to a method for manufacturing an article comprising curing a composition comprising at least one elastomer, at least one organic peroxide, at least one sulfur-containing compound chosen among the group consisting of dialkyl phosphorodithioic acid and salts thereof, in the full or partial presence of oxygen.

The invention also pertains to an article, preferably an article chosen among the group consisting of a seal, hose or gasket, obtained from the aforementioned method.

### BACKGROUND OF THE INVENTION

Polymers and copolymers crosslinked with organic peroxides are known to have superior properties, particularly compared to polymers crosslinked by sulfur cure. These properties include high heat ageing resistance, low percent compression set, decreased staining of metal, and easy production of colored products with enhanced color stability. In view of these beneficial properties, peroxide cure has a great deal of practical importance. A possible drawback of peroxide cure is that air must be excluded from the surface of a material during cure; if air is not excluded, a tacky surface may result, due to cure inhibition by oxygen. In other words, peroxide cure of elastomers in the presence of atmospheric oxygen alters the surface of the produced material by rendering its surface substantially tacky.

In particular, when oxygen comes into contact with an elastomer being crosslinked by an organic peroxide, the crosslinking reaction at the elastomer surface may be inhibited, or may not take place at all. Thus, the elastomer surface remains uncured. Therefore, curing rubber articles with peroxides is typically conducted in steam tubes, molten salt baths, steam autoclaves, and air-evacuated closed molds, all of which are designed to apply heat to the elastomer while excluding atmospheric oxygen during the crosslinking process.

Unfortunately, excluding air from these commercial processes involves a considerable amount of time and surges their costs, especially to ensure the complete exhaustion of air and oxygen from the medium where the crosslinking reaction takes place.

In contrast, sulfur vulcanization of elastomers can be conducted using lower cost hot air ovens or tubes in which hot atmospheric oxygen poses no issue. While the sulfur curatives are generally lower in cost than organic peroxides, the types of elastomers suitable for sulfur cure are limited to unsaturated elastomers, e.g., poly(ethylene propylene diene), poly(butadiene), natural rubber, synthetic poly(isoprene), poly(styrene-butadiene) rubber, poly(butadiene-acrylonitrile) rubber and the like.

In many cases, manufacturers would like to switch from sulfur to peroxide cure using existing hot air ovens; however, curing with conventional peroxide systems under these circumstances would not be viable due to the surface cure inhibition by oxygen. Various methods have been then suggested for preventing surface cure inhibition by oxygen during free radical crosslinking. These methods have, for various reasons, generally met with little or no success.

As a result, organic peroxide formulations comprising at least one sulfur-containing compound have been recently implemented in order to alleviate these shortcomings, especially to significantly reduce the surface tackiness of elastomeric articles that are peroxide cured in the full or partial presence of oxygen. The sulfur-containing compound used in such formulations can be organic sulfide compounds, which may be monosulfides, disulfides, trisulfides or higher polysulfides. Especially, the sulfur-containing compound can be selected from the group consisting of poly(t-amylphenol disulfide); poly(t-butylphenol disulfide); 4,4-dithiodimorpholine; benzothiazyl disulfide; N,N′-caprolactam disulfide; and a combination thereof, and preferably corresponds to poly(t-amylphenol disulfide) sold under the name Vultac® 5.

However, even if such peroxide formulations can provide a tack-free surface, or substantially tack-free surface, when curing an elastomer composition in the full or partial presence of oxygen, especially in the presence of hot air, it has been observed that the mechanical properties of the produced elastomeric articles faltered at the same time.

Indeed, the implementation of such peroxide formulations may namely hinder their high heat ageing resistance, including their tensile properties such as the tensile strength at break, and their percentage compression set. In particular, it has been noted that the tensile strength at break of the produced elastomeric articles can in some cases severally dwindle while the percent compression set may soar. Hence the obtained cured elastomers are not high temperature resistant as they can display permanent deformation under heat and pressure.

It bespeaks that peroxide formulations mixed with the aforementioned sulfur-containing compounds cannot provide a tack-free surface while providing at the same time the desirable mechanical properties obtained with peroxide cure as some of them can even significantly dwindle.

Accordingly, it remains a real need to provide compositions which are able to cure commercially available elastomers and/or elastomer compositions in the full or partial presence of atmospheric oxygen without hampering their mechanical properties, preferably their mechanical properties after heat aging.

In particular, one of the goals of the present invention is to provide compositions which are able to lead to articles having at the same time a tack-free surface, or substantially tack-free surface, and enhanced mechanical properties, especially after heat aging.

More specifically, another goal of the present invention is to obtain an article having a tack-free surface, or substantially tack-free surface, and an improved tensile strength at break and a better compression set.

### DESCRIPTION OF THE INVENTION

The present invention namely results from the unexpected findings, by the inventor, that the implementation of a composition comprising at least one organic peroxide and at least one sulfur-containing compound chosen among the group consisting of dialkyl phosphorodithioic acid and salts thereof, at a concentration as defined hereafter, is able to cure at least one elastomer in order to obtain articles having at the same time a tack-free surface, or substantially tack-free surface and enhanced mechanical properties, especially after heat aging.

Therefore, the present invention relates to a composition comprising:
a) at least one organic peroxide,
b) at least one sulfur-containing compound chosen among the group consisting of dialkyl phosphorodithioic acid and salts thereof, in particular zinc dialkyl dithiophosphates,
c) optionally sulfur under its free form,
d) at least one filler,

wherein the weight ratio between said at least one organic peroxide and said at least one sulfur-containing compound is higher than 0.3, preferably higher than 0.5, even more preferably higher than 0.8,
wherein the weight ratio between sulfur under its free form and said at least one organic peroxide is lower than 0.15, preferably lower than 0.1,
wherein the weight ratio between said at least one filler and said at least one organic peroxide is higher than 10.

The composition of the present invention allows the curing of elastomers, unsaturated or saturated, in the full or partial presence of atmospheric oxygen (e.g., using a hot air oven or tunnel, or steam autoclave) which allows to save time and extra costs compared to organic peroxide cure without altering at the same time the mechanical properties of the cured elastomers.

Furthermore, the composition of the present invention namely leads to the production of articles having a tack-free surface, or substantially tack-free surface, and exhibiting better mechanical properties after heat aging than articles cured with organic peroxide formulations containing at least one sulfur-containing compound chosen among the group consisting of poly(t-amylphenol disulfide); poly(t-butylphenol disulfide); 4,4-dithiodimorpholine; benzothiazyl disulfide; N,N′-caprolactam disulfide; and mixtures thereof.

In particular, the composition of the present invention allows to obtain articles displaying enhanced tensile properties and compression set, and specifically a high tensile strength at break and a low percentage compression set at the same time.

According to the present invention, when heat and pressure are applied to a sulfur-cured elastomer, the sulfur bonds typically break and re-form, causing the deformation of the elastomer. One test to monitor this deformation is called percentage (%) compression set test. The greater the crosslinked elastomer specimen exhibits permanent deformation under heat and pressure, the higher the percentage compression set value. Thus, lower percentage compression set values, equating to less or no permanent elastomer deformation, are desirable for many elastomers, particularly for hose, gasket and sealing applications.

As a result, the aforementioned composition advantageously yields products, in particular elastomeric products, having enhanced mechanical properties suitable for hose, gasket and sealing applications.

It bespeaks that the composition of the present invention produces tack-free surface, or substantially tack-free surface, and high temperature resistant elastomeric products suitable for various applications, such as hose, gasket and sealing applications.

In addition, the composition of the present invention allows the curing of elastomers in a shorter range of time than formulations based solely on organic peroxide or formulations containing a mixture of organic peroxide and at least one sulfur-containing compound chosen among the group consisting of poly(t-amylphenol disulfide); poly(t-butylphenol disulfide); 4,4-dithiodimorpholine; benzothiazyl disulfide; N,N′-caprolactam disulfide; and mixtures thereof.

In other words, the composition of the present invention can significantly reduce the surface tackiness of an article, preferably an elastomeric article, that is peroxide cured in the full or partial presence of oxygen, that is to say in an open system, and can provide short curing times, high tensile strength at break and low percentage compression set.

Another subject-matter of the present invention pertains to a method for manufacturing an article comprising curing a composition comprising a) at least one elastomer, b) at least one organic peroxide, c) at least one sulfur-containing compound chosen among the group consisting of dialkyl phosphorodithioic acid and salts thereof, in particular zinc dialkyl dithiophosphates, d) optionally sulfur under its free form, in the full or partial presence of oxygen; wherein in said composition the weight ratio between said at least one organic peroxide and said at least one sulfur-containing compound is higher than 0.3 and the weight ratio between sulfur under its free form and said at least one organic peroxide is lower than 0.15, preferably lower than 0.1.

In other words, the aforementioned method comprises, consists essentially of, or consists of curing a composition in the partial or full presence of oxygen, wherein said composition comprises at least one elastomer, at least one organic peroxide, at least one sulfur-containing compound chosen among the group consisting of dialkyl phosphorodithioic acid and salts thereof, in particular zinc dialkyl dithiophosphates, optionally sulfur under its free form, wherein the weight ratio between said at least one organic peroxide and said at least one sulfur-containing compound is higher than 0.3 and the weight ratio between sulfur under its free form and said at least one organic peroxide is lower than 0.15.

The method of the invention is less expensive to implement than commercial processes wherein air is excluded and can be achieved in a relatively short period of time.

Another aspect of the present invention pertains to an article, preferably an elastomeric article, comprising at least the aforementioned composition in cured form and which is preferably completely or substantially tack-free.

Preferably, such an article can be chosen among the group consisting of a seal, hose or gasket. The articles can be extruded or molded using methods known in the art. These articles can be cured in hot air, microwave/UHF, infra-red heat and/or steam autoclave where steam purging time of atmospheric oxygen can be shortened or eliminated, while providing a fully cured surface with improved heat aging properties. The invention also deals with an article, preferably an elastomeric article, obtained from the aforementioned method.

Moreover, the invention relates to the use of the composition according to the present invention in order to improve the mechanical properties, especially the tensile properties and the compression set, of a composition comprising at least one elastomer.

The enhanced tensile properties are preferably the tensile strength and/or the percentage of elongation at break.

Other subjects and characteristics, aspects and advantages of the invention will emerge even more clearly on reading the description and the example that follows.

In the text herein below, and unless otherwise indicated, the limits of a range of values are included in that range, in particular in the expressions “between” and “ranging from . . . to . . . ”.

Moreover, the expression “at least one” used in the present description is equivalent to the expression “one or more”.

### Composition

As intended herein, the term “comprising” has the meaning of “including” or “containing”, which means that when an object “comprises” one or several elements, other elements than those mentioned may also be included in the object. In contrast, when an object is said to “consist of” one or several elements, the object is limited to the listed elements and cannot include other elements than those mentioned.

According to the present invention, the term “polymer” encompasses homopolymers and copolymers, where the term “copolymers” refers to a polymer comprised of at least two different monomers in polymerized form. For example, a copolymer in accordance with the present disclosure may be a polymer comprising two different monomers, a terpolymer is a polymer comprising three different monomers or more.

As previously detailed, the composition according to the present invention comprises:
a) at least one organic peroxide,
b) at least one sulfur-containing compound chosen among the group consisting of dialkyl phosphorodithioic acid and salts thereof, in particular zinc dialkyl dithiophosphates,
c) optionally sulfur under its free form,
d) at least one filler
wherein the weight ratio between said at least one organic peroxide and said at least one sulfur-containing compound is higher than 0.3, preferably higher than 0.5, more preferably higher than 0.8,
wherein the weight ratio between sulfur under its free form and said at least one organic peroxide is lower than 0.15, preferably lower than 0.1,
wherein the weight ratio between said at least one filler and said at least one organic peroxide is higher than 10.

The organic peroxide used in the aforementioned composition is preferably solid at room temperature.

According to the present invention, the expression “room temperature” stands for a range of temperatures of from 15° C. to 30° C., preferably from 20° C. to 30° C.

The organic peroxide can be chosen among the group consisting of dialkyl peroxides, hemi-perketal peroxides (e.g., Luperox® V10), diperoxyketals, mono-peroxy carbonates, cyclic ketone peroxides, diacyl peroxides, organosulfonyl peroxides, peroxyesters and solid, room temperature stable peroxydicarbonates.

Preferably, the organic peroxide is selected from the group consisting of dialkyl peroxides, peroxyketals, cyclic ketone peroxides, monoperoxycarbonates, peroxyesters, diacyl peroxides and mixtures thereof, preferably dialkyl peroxides.

Peroxide names and physical properties for all these classes of organic peroxides can be found in “Organic Peroxides” by Jose Sanchez and Terry N. Myers; Kirk-Othmer Encyclopedia of Chemical Technology, Fourth Ed., Volume 18, (1996), the disclosure of which is incorporated herein by reference.

Illustrative dialkyl peroxide initiators include:
di-t-butyl peroxide;
t-butyl cumyl peroxide;
2,5-di(cumylperoxy)-2,5-dimethyl hexane;
2,5-di(cumylperoxy)-2,5-dimethyl hexyne-3;
4-methyl-4-(t-butylperoxy)-2-pentanol;
4-methyl-4-(t-amylperoxy)-2-pentanol;
4-methyl-4-(cumylperoxy)-2-pentanol;
4-methyl-4-(t-butylperoxy)-2-pentanone;
4-methyl-4-(t-amylperoxy)-2-pentanone;
4-methyl-4-(cumylperoxy)-2-pentanone;
2,5-dimethyl-2,5-di(t-butylperoxy)hexane;
2,5-dimethyl-2,5-di(t-amylperoxy)hexane;
2,5-dimethyl-2,5-di(t-butylperoxy)hexyne-3;
2,5-dimethyl-2,5-di(t-amylperoxy)hexyne-3;
2,5-dimethyl-2-t-butylperoxy-5-hydroperoxyhexane;
2,5-dimethyl-2-cumylperoxy-5-hydroperoxy hexane;
2,5-dimethyl-2-t-amylperoxy-5-hydroperoxyhexane;
m/p-alpha, alpha-di[(t-butylperoxy)isopropyl]benzene;
m-alpha, alpha-di[(t-butylperoxy)isopropyl]benzene;
p-alpha, alpha-di[(t-butylperoxy)isopropyl]benzene;
1,3,5-tris(t-butylperoxyisopropyl)benzene;
1,3,5-tris(t-amylperoxyisopropyl)benzene;
1,3,5-tris(cumylperoxyisopropyl)benzene;
di[1,3-dimethyl-3-(t-butylperoxy)butyl]carbonate;
di[1,3-dimethyl-3-(t-amylperoxy)butyl]carbonate;
di[1,3-dimethyl-3-(cumylperoxy)butyl]carbonate;
di-t-amyl peroxide;
dicumyl peroxide;
t-butylperoxy-meta-isopropenyl-cumyl peroxide;
t-amyl cumyl peroxide;
t-butyl-isopropenylcumylperoxide;
2,4,6-tri(butylperoxy)-s-triazine;
1,3,5-tri[1-(t-butylperoxy)-1-methylethyl]benzene
1,3,5-tri-[(t-butylperoxy)-isopropyl]benzene;
1,3-dimethyl-3-(t-butylperoxy)butanol;
1,3-dimethyl-3-(t-amylperoxy)butanol; and mixtures thereof.

Other dialkylperoxides which may be used singly or in combination with the other free radical initiators contemplated by the present invention are those selected from the group represented by the formula (I):

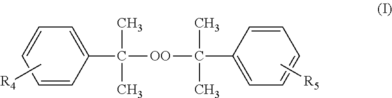

wherein R₄ and R₅ may independently be in the meta or para positions and are the same or different and are selected from hydrogen or straight or branched chain alkyls of 1 to 6 carbon atoms. Dicumyl peroxide and isopropylcumyl cumyl peroxide are illustrative.

Other dialkyl peroxides include:
3-cumylperoxy-1,3-dimethylbutyl methacrylate;
3-t-butylperoxy-1,3-dimethylbutyl methacrylate;
3-t-amylperoxy-1,3-dimethylbutyl methacrylate;
tri(1,3-dimethyl-3-t-butylperoxy butyloxy)vinyl silane;
1,3-dimethyl-3-(t-butylperoxy)butyl N-[1-{3-(1-methylethenyl)-phenyl}1-methylethyl]carbamate;
1,3-dimethyl-3-(t-amylperoxy)butyl N-[1-{3(1-methylethenyl)-phenyl}-1-methylethyl]carbamate;
1,3-dimethyl-3-(cumylperoxy))butyl N-[1-{3-(1-methylethenyl)-phenyl}-1-methylethyl]carbamate.

Other dialkylperoxides which may be used singly or in combination with the other free radical initiators contemplated by the present invention are those dialkyl peroxides including a thioxanthone group, represented by the following formula (II):

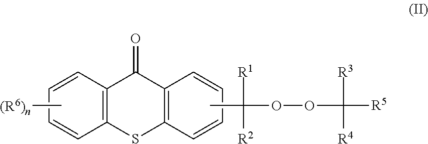

wherein R¹, R², R³, and R⁴ each independently represent a methyl or ethyl group; R⁵ represents a C₁₋₆ alkyl group or a phenyl group; R⁶ represents a C₁₋₄ alkyl group, a C₁₋₄ alkoxy group, or a chlorine atom; and n is an integer from 0 to 2.

In the group of diperoxyketal initiators, the preferred initiators include:
1,1-di(t-butylperoxy)-3,3,5-trimethylcyclohexane;
1,1-di(t-butylperoxy)cyclohexane;
n-butyl 4,4-di(t-amylperoxy)valerate;
ethyl 3,3-di(t-butylperoxy)butyrate;
2,2-di(t-amylperoxy)propane;
3,6,6,9,9-pentamethyl-3-ethoxycabonylmethyl-1,2,4,5-tetraoxacyclononane;
n-butyl-4,4-bis(t-butylperoxy)valerate;
ethyl-3,3-di(t-amylperoxy)butyrate; and mixtures thereof.

Illustrative solid, room temperature stable peroxydicarbonates include, but are not limited to: di(2-phenoxyethyl)peroxydicarbonate; di(4-t-butyl-cyclohexyl)peroxydicarbonate; dimyristyl peroxydicarbonate; dibenzyl peroxydicarbonate; and di(isobornyl)peroxydicarbonate. Other peroxides that may be used according to at least one embodiment of the present invention include benzoyl peroxide, OO-t-butyl-O-hydrogen-monoperoxy-succinate and OO-t-amyl-O-hydrogen-monoperoxy-succinate.

Illustrative cyclic ketone peroxides are compounds having the general formulae (III), (IV) and/or (V).

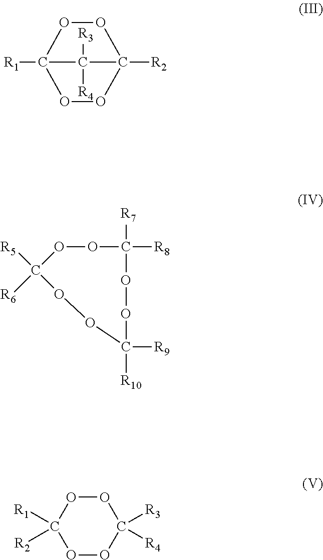

wherein R₁ to R₁₀ are independently selected from the group consisting of hydrogen, C1 to C20 alkyl, C3 to C20 cycloalkyl, C6 to C20 aryl, C7 to C20 aralkyl and C7 to C20 alkaryl, which groups may include linear or branched alkyl properties and each of R₁ to R₁₀ may be substituted with one or more groups selected from hydroxy, C1 to C20 alkoxy, linear or branched C1 to C20 alkyl, C6 to C20 aryloxy, halogen, ester, carboxy, nitride and amido, such as, for example, at least 20% of the total active oxygen content of the peroxide mixture used for a crosslinking reaction will be from compounds having formulae (III), (IV) and/or (V).

Some examples of suitable cyclic ketone peroxides include:
3,6,9,triethyl-3,6,9-trimethyl-1,4,7-triperoxynonane (or methyl ethyl ketone peroxide cyclic trimer), methyl ethyl ketone peroxide cyclic dimer, and 3,3,6,6,9,9-hexamethyl-1,2,4,5-tetraoxacyclononane.

Illustrative examples of peroxy esters include:
2,5-dimethyl-2,5-di(benzoylperoxy)hexane;
t-butylperbenzoate;
t-butylperoxy acetate;
t-butylperoxy-2-ethyl hexanoate;
t-amyl perbenzoate;
t-amyl peroxy acetate;
t-butyl peroxy isobutyrate;
3-hydroxy-1,1-dimethyl t-butyl peroxy-2-ethyl hexanoate;
OO-t-amyl-O-hydrogen-monoperoxy succinate;
OO-t-butyl-O-hydrogen-monoperoxy succinate;
di-t-butyl diperoxyphthalate;
t-butylperoxy (3,3,5-trimethylhexanoate);
1,4-bis(t-butylperoxycarbo)cyclohexane;
t-butylperoxy-3,5,5-trimethylhexanoate;
t-butyl-peroxy-(cis-3-carboxy)propionate;
allyl 3-methyl-3-t-butylperoxy butyrate.

Illustrative monoperoxy carbonates include:
OO-t-butyl-O-isopropylmonoperoxy carbonate;
OO-t-amyl-O-isopropylmonoperoxy carbonate.
OO-t-hexyl-O-isopropylmonoperoxy carbonate.
OO-t-butyl-O-(2-ethyl hexyl)monoperoxy carbonate;
OO-t-amyl-O-(2-ethyl hexyl)monoperoxy carbonate;
OO-t-hexyl-O-(2-ethyl hexyl)monoperoxy carbonate;
1,1,1-tris[2-(t-butylperoxy-carbonyloxy)ethoxymethyl]propane;
1,1,1-tris[2-(t-amylperoxy-carbonyloxy)ethoxymethyl]propane;
1,1,1-tris[2-(cumylperoxy-cabonyloxy)ethoxymethyl]propane.

Illustrative diacyl peroxides include:
di(4-methylbenzoyl)peroxide;
di(3-methylbenzoyl)peroxide;
di(2-methylbenzoyl)peroxide;
didecanoyl peroxide; dilauroyl peroxide;
2,4-dibromo-benzoyl peroxide;
succinic acid peroxide.
dibenzoyl peroxide;
di(2,4-dichloro-benzoyl)peroxide; and mixtures thereof.

Imido peroxides of the type described in PCT Application publication WO9703961 A1 6 Feb. 1997 are also contemplated as suitable for use and incorporated by reference herein.

Preferred peroxides include one or more of: 2,5-di(t-butylperoxy)-2,5-dimethyl hexane; t-butyl cumyl peroxide; 2,5-dimethyl-2,5-di(t-butylperoxy)hexyne-3; t-butylperoxy-isopropenylcumylperoxide; 3,3,5,7,7-pentamethyl,-1,2,4-trioxepane; 3,6,9, triethyl-3,6,9-trimethyl-1,4,7-triperoxynonane; m/p-di(t-butylperoxy)diisopropyl benzene; m-di(t-butylperoxy)diisopropyl benzene; p-di(t-butylperoxy)diisopropyl benzene; di-t-butyl peroxide; di-t-amyl peroxide; dicumyl peroxide; 1,1-di(t-butylperoxy)-3,3,5-trimethylcyclohexane; 1,1-di(t-butylperoxy)cyclohexane; n-butyl 4,4-di(t-butylperoxy)valerate; ethyl 3,3-di(t-butylperoxy)butyrate; OO-t-butyl-O-(2-ethyl hexyl)monoperoxy carbonate; OO-t-butyl-O-isopropylmonoperoxy carbonate; polyether poly-t-butylperoxy carbonate; t-butylperoxybenzoate; t-butylperoxyacetate; t-butylperoxymaleic acid; di(4-methylbenzoyl)peroxide; dibenzoyl peroxide; di(2,4-dichlorobenzoyl)peroxide; dilauroyl peroxide; cumene hydroperoxide; and di(4-tert-butylcyclohexyl)peroxydicarbonate.

More preferred peroxides include one or more of: 1,3(4)-bis[1-(tert-butylperoxy)-1-methylethyl]benzene, 1,1-di(t-butylperoxy)-3,3,5-trimethylcyclohexane, t-butylperoxybenzoate, t-butyl-2-ethylhexylmonoperoxycarbonate, 2,5-dimethyl-2,5-di(t-butylperoxy)hexane, 2,5-di(t-butylperoxy)-2,5-dimethyl hexane; t-butyl cumyl peroxide; 2,5-dimethyl-2,5-di(t-butylperoxy)hexyne-3; t-butylperoxy-isopropenylcumylperoxide; 3,3,5,7,7-pentamethyl,-1,2,4-trioxepane; 3,6,9,triethyl-3,6,9-trimethyl-1,4,7-triperoxynonane; m/p-di(t-butylperoxy)diisopropyl benzene; m-di(t-butylperoxy)diisopropyl benzene; p-di(t-butylperoxy)diisopropyl benzene; di-t-butyl peroxide; dicumyl peroxide; 1,1-di(t-butylperoxy)-3,3,5-trimethylcyclohexane; 1,1-di(t-butylperoxy)cyclohexane; n-butyl 4,4-di(t-butylperoxy)valerate; ethyl 3,3-di(t-butylperoxy)butyrate; OO-t-butyl-O-(2-ethyl hexyl)monoperoxy carbonate; OO-t-butyl-O-isopropylmonoperoxy carbonate; polyether poly-t-butylperoxy carbonate; t-butylperoxybenzoate; dibenzoyl peroxide; di(2,4-dichlorobenzoyl)peroxide; cumene hydroperoxide; and di(4-tert-butylcyclohexyl)peroxydicarbonate.

Even more preferred peroxides include one or more of: 1,3(4)-bis[1-(tert-butylperoxy)-1-methylethyl]benzene, 1,1-di(t-butylperoxy)-3,3,5-trimethylcyclohexane, t-butylperoxybenzoate, t-butyl-2-ethylhexylmonoperoxycarbonate, 2,5-dimethyl-2,5-di(t-butylperoxy)hexane, 2,5-di(t-butylperoxy)-2,5-dimethyl hexane; t-butyl cumyl peroxide; 2,5-dimethyl-2,5-di(t-butylperoxy)hexyne-3; t-butylperoxy-isopropenylcumylperoxide; 3,3,5,7,7-pentamethyl,-1,2,4-trioxepane; m/p-di(t-butylperoxy)diisopropyl benzene; m-di(t-butylperoxy)diisopropyl benzene; p-di(t-butylperoxy)diisopropyl benzene; di-t-butyl peroxide; dicumyl peroxide; 1,1-di(t-butylperoxy)-3,3,5-trimethylcyclohexane; 1,1-di(t-butylperoxy)cyclohexane; n-butyl 4,4-di(t-butylperoxy)valerate; ethyl 3,3-di(t-butylperoxy)butyrate; OO-t-butyl-O-(2-ethyl hexyl)monoperoxy carbonate; OO-t-butyl-O-isopropylmonoperoxy carbonate; t-butylperoxybenzoate; dibenzoyl peroxide; and di (2,4-dichlorobenzoyl)peroxide.

Most preferred peroxides include one or more of: 1,3(4)-bis[1-(tert-butylperoxy)-1-methylethyl]benzene, 1,1-di(t-butylperoxy)-3,3,5-trimethylcyclohexane, t-butylperoxybenzoate, t-butyl-2-ethylhexylmonoperoxycarbonate, 2,5-dimethyl-2,5-di(t-butylperoxy)hexane, dicumyl peroxide, and t-butylcumylperoxide, and mixtures thereof, preferably 1,3(4)-bis[1-(tert-butylperoxy)-1-methylethyl]benzene.

The organic peroxide is preferably selected from the group consisting of dialkyl peroxides.

Especially, the organic peroxide is m/p-di(t-butylperoxy)diisopropyl benzene (or 1,3(4)-bis[1-(tert-butylperoxy)-1-methylethyl]benzene), specifically sold under the commercial name Luperox® F.

The composition according to the present invention further comprises at least one sulfur-containing compound chosen among the group consisting of dialkyl phosphorodithioic acid and salts thereof, preferably dialkyl dithiophosphates salts.

Preferably, the dialkyl dithiophosphates salt is chosen in the group consisting of dialkyl dithiophosphates zinc salt, dialkyl dithiophosphates calcium salt and dialkyl dithiophosphates copper salt, more preferably is zinc dialkyl dithiophosphates.

Dialkyl dithiophosphates salts can preferably have the following formula (VI):

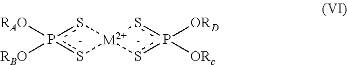

wherein R_{A}, R_{B}, R_{C} and R_{D}, identical or different, represent:
a linear or branched C₁-C₃₀ alkyl radical, especially a linear or branched C₁-C₁₄ alkyl radical, or
a cyclic alkyl group comprising from 4 to 30 carbon atoms, especially from 4 to 10 carbon atoms
M²⁺ is a divalent metal, preferably chosen in the group consisting of zinc, calcium and copper, more preferably M²⁺ is zinc.

Preferably, R_{A}, R_{B}, R_{C} and R_{D}, identical or different, represent a linear or branched C₁-C₃₀ alkyl radical, especially a linear or branched C₁-C₁₄ alkyl radical.

More preferably, R_{A}, R_{B}, R_{C} and R_{D} are identical and represent a linear or branched C₁-C₃₀ alkyl radical, especially a linear or branched C₁-C₁₄ alkyl radical.

Even more preferably, R_{A}, R_{B}, R_{C} and R_{D} are identical and represent a linear C₁-C₁₄ alkyl radical, especially a linear C₁-C₄ alkyl radical.

When M²⁺ is zinc, the dialkyl dithiophosphate salt has the following formula (VII):

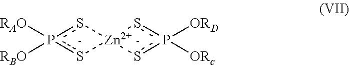

wherein R_{A}, R_{B}, R_{C} and R_{D}, are as described above.

The dialkyl dithiophosphate salts, in particular zinc dialkyl dithiophosphate can be in the form of monomer, dimer, trimer or polymer.

Preferably, the sulfur-containing compound is chosen in the group consisting of phosphorodithioic acid, OO-di-C1-14-alkyl esters, zinc salts, phosphorodithioic acid, mixed OO-bis(2-ethylhexyl and iso-Bu and iso-Pr) esters, zinc salts and phosphorodithioic acid, mixed OO-bis(2-ethylhexyl and iso-Bu) esters, zinc salts, more preferably is phosphorodithioic acid, OO-di-C1-14-alkyl esters, zinc salts.

The weight ratio between said at least one organic peroxide and said at least one sulfur-containing compound is higher than 0.3, preferably higher than 0.5, even more preferably higher than 0.8.

Preferably, the weight ratio between said at least one organic peroxide and said at least one sulfur-containing compound is lower than 200, preferably lower than 50, even more preferably lower than 20.

Preferably, the weight ratio between said at least one organic peroxide and said at least one sulfur-containing compound is comprised between 0.1 to 200, preferably from 0.3 and 20, preferably between 0.5 and 20, even more preferably between 0.8 and more specifically between 1 and 20.

Preferably, the weight ratio between said at least one organic peroxide and the sulphur contained in the at least one sulfur-containing compound is higher than 1.5, preferably higher than 2.5, even more preferably higher than 4.

Preferably, the weight ratio between said at least one organic peroxide and the sulphur contained in the at least one sulfur-containing compound is lower than 1000, preferably lower than 250, even more preferably lower than 100.

The composition may further comprise sulfur under its free form.

According to the present invention, the expression “sulfur under its free form” means that sulfur is present in the composition under its elemental form, that is to say as a free atom.

In other words, the sulfur under its free form refers to sulfur as a free atom which is not linked to other atoms, especially via covalent bonds.

The weight ratio between sulfur under its free form and said at least one organic peroxide is lower than 0.15, preferably lower than 0.1.

The composition further comprises at least one filler.

According to the present invention, the term “filler” namely refers to an inactive organic or inorganic material or a combination thereof

The filler can be chosen among the group consisting of water washed clay, e.g., Burgess Clay, black carbon, calcium carbonate, silica, precipitated silica, calcium silicate, kaolin, liquid saturated hydrocarbon, and combination thereof.

Preferably, the filler is chosen among the group consisting of black carbon, calcium carbonate, silica, kaolin, liquid saturated hydrocarbon and combination thereof, more preferably black carbon and liquid saturated hydrocarbon.

The weight ratio between said at least one filler and said at least one organic peroxide is higher than 10, preferably higher than 12, more preferably higher than 15.

According to the present invention, the expression “higher than 10” means that the value 10 is excluded.

The composition according to the present invention can further comprise at least one elastomer.

In other words, a subject-matter of the present invention can be an elastomer composition comprising:
a) at least one elastomer,
b) at least one organic peroxide,
c) at least one sulfur-containing compound chosen among the group consisting of dialkyl phosphorodithioic acid and salts thereof, in particular zinc dialkyl dithiophosphates,
d) optionally sulfur under its free form,
e) at least one filler,
wherein the weight ratio between said at least one organic peroxide and said at least one sulfur-containing compound is higher than 0.3,
wherein the weight ratio between sulfur under its free form and said at least one organic peroxide is lower than 0.15,
wherein the weight ratio between said at least one filler and said at least one organic peroxide is higher than 10.

According to the present invention, the elastomer is namely curable in the full or partial presence of oxygen.

The elastomer can be saturated or unsaturated.

Preferably, the elastomer is saturated and can be selected from the group consisting of silicon rubber without unsaturation (Q), methyl-polysiloxane (MQ), phenyl-methyl-polysiloxane (PMQ), poly(ethylene-vinyl acetate) (EVA), high-density polyethylene (HDPE), low-density polyethylene (LDPE), chlorinated poly(ethylene) (CM or CPE), poly(ethylene-propylene) (EPM), fluoroelastomers (FKM, FFKM) (e.g., Viton® and Dyneon®), and combinations thereof.

Preferably, the elastomer is unsaturated and can be selected from the group consisting of ethylene-propylene-diene terpolymer (EPDM), vinyl silicone rubber (VMQ), fluorosilicone (FVMQ), nitrile rubber (NBR), acrylonitrile-butadiene-styrene (ABS), styrene butadiene rubber (SBR), styrene-butadiene-styrene block copolymers (SBS), polybutadiene rubber (BR), styrene-isoprene-styrene block copolymers (SIS), partially hydrogenated acrylonitrile butadiene (HNBR), natural rubber (NR), synthetic polyisoprene rubber (IR), neoprene rubber (CR), polychloropropene, bromobutyl rubber (BIIR), chlorobutyl rubber, and combinations thereof.

Preferably, the unsaturated elastomer is an ethylene-propylene-diene terpolymer (EPDM).

It should be noted that commercially-available pre-compounded elastomers may be used in accordance with the present invention. These elastomers may contain additives such as carbon black filler, process oils, mold release agents, antioxidants and/or heat stabilizers. According to particular embodiments, the at least one elastomer is part of an elastomer masterbatch that includes one or more of these additives. For example, an elastomer masterbatch may comprise, consist essentially of, or consist of the at least one elastomer and one or more additives selected from the group consisting of carbon black, polyethylene glycol, at least one process oil (e.g., liquid saturated hydrocarbons, such as Primol® 352), at least one antioxidant (e.g., 2,2,4-trimethyl-1,2-dihydroquinoline, CAS #26780-96-1 also referred to as Stanguard® TMQ Powder), at least one mold release agent, at least one heat stabilizer, and a combination thereof.

Preferably, the organic peroxide is present in the composition of the present invention in an amount from 0.1 phr to 300 phr (parts per hundred rubber), preferably from 0.1 phr to 20 phr, preferably from 0.2 to 10 phr, preferably from 0.2 phr to 5 phr, preferably from 0.2 phr to 2 phr, preferably from 0.2 phr to 1 phr, more preferably from phr to 0.6 phr.

The sulfur-containing compound is preferably present in the composition of the present invention at a concentration lower than 3.3 phr (parts per hundred rubber); the value 3.3 phr being excluded.

Preferably, the sulfur-containing compound is present in the composition of the present invention at a concentration ranging from 0.1 to 3.2 phr, preferably from 0.1 to 3 phr, preferably from 0.1 to 2.5 phr, preferably 0.5 to 2.5 phr and more preferably from 1 to 2.5 phr.

Preferably, the organic peroxide is present in the composition in an amount from 0.2 to 0.6 phr and the sulfur-containing compound is present in the composition in an amount from 0.5 to 2.5 phr.

The sulfur from the sulfur-containing compound is preferably present in the composition at a concentration lower than 0.6 phr (parts per hundred rubber); the value 0.6 phr being excluded.

Preferably, the sulfur from the sulfur-containing compound is present in the composition of the present invention at a concentration ranging from 0.02 to 0.6 phr, preferably from 0.02 to 0.5 phr, preferably 0.1 to 0.5 phr and more preferably from 0.2 to 0.5 phr.

The composition may further comprise sulfur under its free form in an amount ranging from 0 to 0.5 phr, preferably from 0 to 0.4 phr, more preferably from 0 to 0.3 phr, more preferably from 0 to 0.2 phr, even more preferably from 0 to 0.1 phr.

In other words, the composition optionally comprises sulfur under its free form which may be present in an amount from 0 to 0.5 phr.

In still other words, when the composition comprises sulfur under its free form, its concentration is lower than or equal to 0.5 phr, preferably lower than 0.4 phr, more preferably lower than 0.3 phr, and even more preferably lower than 0.1 phr.

According to an embodiment, the invention pertains to an elastomer composition comprising:
a) at least one elastomer,
b) at least one organic peroxide,
c) at least one sulfur-containing compound chosen among the group consisting of dialkyl phosphorodithioic acid and salts thereof, in particular zinc dialkyl dithiophosphates,
d) optionally sulfur under its free form,
e) at least one filler,
wherein the organic peroxide is present at a concentration comprised between 0.1 phr and 20 phr,
wherein the sulfur-containing compound is present at a concentration lower than 3.3 phr,
wherein sulfur under its free form is present in an amount from 0 to 0.5 phr, and
wherein the filler is present in an amount of at least 10 phr.

The composition according to the present invention may further comprise at least one HALS (Hindered Amine Light Stabilizer) compound.

The HALS compound may be selected from the group consisting of poly[[6-[(1,1,3,3-tetramethylbutyl)amino]-s-triazine-2,4-diyl]-[(2,2,6,6-tetramethyl-4-piperidyl)imino]-hexamethylene-[(2,2,6,6-tetramethyl-4-piperidyl)imino]] (especially sold under the name Chimassorb® 944), [bis(2,2,6,6-tetramethyl-4-piperidinyl)sebacate] (especially sold the name Tinuvin® 770), and mixture thereof.

The composition according to the present invention may further comprise at least one antioxidant, preferably phenolic antioxidant.

The phenolic antioxidant is preferably selected among the group consisting of 2,6-diocta-decyl-p-cresol, 2,6-di-tertiary-butyl-4-methyl phenol; 2,4,6-tri(. alpha.-methyl benzyl) phenol; 2,4-di-methyl-6-tertiary-butyl phenol; 2,6-di-isopropyl-4-methyl phenol; 2,6-di-tertiary amyl-4-methyl phenol; 2,4,6-tri-tertiary amyl phenol; 2,6-di-tertiary amyl-4-tertiary butyl phenol; 2,4,6-tri-tertiary butyl phenol; 2,4,6-tri-isopropyl phenol; 2,6-di-dodecyl-p-cresol; 2,6-bis(1-methylheptadecyl)-p-cresol; 6-dodecyl-2-(1 methylheptadecyl)-p-cresol; 2-tertiary butyl-6-(1 methylcyclohexyl)-p-cresol and mixtures thereof.

Furthermore, complex hindered phenols having more than two phenol groups in the molecule can effectively be utilized as phenolic antioxidant.

Accordingly, the phenolic antioxidant can also be chosen among the group consisting of 1,3,5-trimethyl-2,4,6-tris (3,5-di-tert-butyl-4-hydroxy benzyl) benzene (available commercially as “Ionox 330” from the Ethyl Corp.); tetrakis [methylene-3-(3′,5′-di-tert butyl-4′-hydroxy phenyl) propionate] methane (available commercially as “Irganox 1010” from Geigy Chemical Co.); 3:1 (on a molar basis) condensate of 3-methyl-6-tert butyl phenol with crotonaldehyde (available commercially as “Topanol CA” from Imperial Chemical Industries, Ltd.).

The composition according to the present invention preferably comprises 2,6-diocta-decyl-p-cresol as at least one phenolic antioxidant.

The composition preferably does not comprise any bis-, tri- or higher poly-maleimides, or bis-, tri- or higher poly-citraconimides, preferably such as HVA-2 (N, N′-m-phenylene dimaleimide).

The composition can further comprise at least one co-agent preferably selected from the group consiting of allyl methacrylate, triallyl cyanurate, triallyl isocyanurate, trimethyloylpropane trimethacrylate (SR-350), trimethyloylpropane triacrylate (SR-351), zinc diacrylate, and zinc dimethacrylate.

The composition can comprise optional additives selected from the group consisting of process oils (e.g., aliphatic process oils), process aids, pigments, dyes, tackifiers, waxes, reinforcing aids, UV stabilization agents, blowing agents, scorch protectors, activators, antiozonants and coagents (e.g., those marketed by Sartomer). The components of the formulations and their respective amounts, are selected such that the formulation is capable of curing said composition in the full or partial presence of oxygen (e.g., using a hot air oven or tunnel, or a steam autoclave).

The scorching protectors can be chosen in the group consisting of organic hydroperoxides, vinyl monomers, nitrites, aromatic amines, phenolic compounds, mercaptothiazole compounds, nitroxides, sulfides, hydroquinones and dialkyl dithio-carbamate compounds.

The composition according to the present invention preferably comprises:
a) at least one organic peroxide chosen from the group consisting of dialkyl peroxides,
b) at least one sulfur-containing compound chosen among the group consisting of dialkyl phosphorodithioic acid and salts thereof, in particular zinc dialkyl dithiophosphates corresponding to formula (VI), preferably formula (VI) wherein R_{A}, R_{B}, R_{C} and R_{D}, identical or different, represent a linear or branched C₁-C₃₀ alkyl radical, especially a linear or branched C₁-C₁₀ alkyl radical, more specifically a a linear C₁-C₁₀ alkyl radical, even more specifically a linear C₁-C₄ alkyl radical,
c) at least one filler, preferably selected from the group consisting of black carbon, calcium carbonate, silica, kaolin, liquid saturated hydrocarbon and combination thereof, more preferably black carbon and liquid saturated hydrocarbon,
d) optionally sulfur under its free form,
wherein the weight ratio between said at least one organic peroxide and said at least one sulfur-containing compound is higher than 0.3, preferably higher than 0.5, even more preferably higher than 0.8,
wherein the weight ratio between sulfur under its free form and said at least one organic peroxide is lower than 0.15, preferably lower than 0.1,
wherein the weight ratio between said at least one filler and said at least one organic peroxide is higher than 10.

Preferably, the elastomer is unsaturated, especially the elastomer corresponds to an ethylene-propylene-diene terpolymer (EPDM).

The composition according to the present invention preferably comprises:
a) at least one unsaturated elastomer,
b) at least one organic peroxide chosen from the group consisting of dialkyl peroxides,
c) at least one sulfur-containing compound chosen among the group consisting of dialkyl phosphorodithioic acid and salts thereof, in particular zinc dialkyl dithiophosphates corresponding to formula (VI), preferably formula (VI) wherein R_{A}, R_{B}, R_{C} and R_{D}, identical or different, represent a linear or branched C₁-C₃₀ alkyl radical, especially a linear or branched C₁-C₁₀ alkyl radical, more specifically a a linear C₁-C₁₀ alkyl radical, even more specifically a linear C₁-C₄ alkyl radical,
d) at least one filler,
e) sulfur under its free form is present in an amount ranging from 0 to 0.5 phr,
wherein the at least one sulfur-containing compound is present in said composition in an amount lower than 3.3 phr, and the organic peroxide is present at a concentration comprised between 0.1 phr to 20 phr,
wherein the filler is present in an amount of at least 10 phr.
wherein the composition is curable in the full or partial presence of oxygen.

Preferably, the sulfur-containing compound is present in the composition of the present invention at a concentration ranging from 0.1 to 3.2 phr, or from 0.1 to 3 phr, or from 0.1 to 2.5phr, 1 from 2.5 phr.

Preferably, the unsaturated elastomer is an ethylene-propylene-diene terpolymer (EPDM).

### Method

The invention also relates to a method for manufacturing an article, preferably an elastomeric article, comprising a step of curing a composition in the full or partial presence of oxygen, said composition comprising:
a) at least one elastomer,
b) at least one organic peroxide,
c) at least one sulfur-containing compound chosen among the group consisting of dialkyl phosphorodithioic acid and salts thereof, in particular zinc dialkyl dithiophosphates,
d) optionally sulfur under its free form,
wherein in said composition the weight ratio between said at least one organic peroxide and said at least one sulfur-containing compound is higher than 0.3, preferably higher than 0.5, more preferably higher than 0.8,
wherein in said composition the weight ratio between sulfur under its free form and said at least one organic peroxide is lower than 0.15, preferably lower than 0.1.

Preferably, the method comprises a step of curing the aforementioned composition.

Preferably, the composition cured in the method further comprises at least one filler, wherein the weight ratio between said at least one filler and said at least one organic peroxide is higher than 10.

As used herein, the term “curing” refers to the crosslinking of a polymer to form a strengthened or hardened polymer. A curing step may be performed in any conventional manner, such as, for example, hot air, steam, or hot molding.

The method may comprise extruding the composition, as described herein, to form an uncured preform article, and curing the uncured preform article. Said composition may be extruded in the presence of air to form the uncured preform.

In at least one embodiment, the preform is cured using a steam autoclave.

Preferably, the extruded profile is heated in a microwave zone in the presence of air directly from the extruder, then passed through a longer heated air tunnel to complete the cure of the elastomeric profile.

In at least one other embodiment, the preform is cured without using microwaves.

The method for manufacturing the article may be performed in a hot air tunnel, or any other known apparatus.

Preferably, the method for manufacturing the article can be formed continuously. Continuous manufacturing may allow for the production of a continuous article, such as a continuous seal, as opposed to seals that must be pieced together from smaller parts.

Another aspect of the present invention is directed to a method as previously defined for manufacturing an article, preferably an elastomeric article, selected among the group consisting of a seal, hose or gasket.

Another aspect of the present invention is directed to a method for manufacturing hose. The method may comprise extruding a length of hose from the composition as previously defined without curing the length of hose. The length of uncured hose may be collected and then cured, such as by exposing the uncured hose to steam.

The process may further comprise mixing the at least one elastomer, the organic peroxide(s), and the sulfur-containing compound(s) as previously defined, and optionally sulfur, and eventually said filler, separately or together, and in any order, to provide the composition as previously described.

According one embodiment of the present invention, one or more conventional additives such as antioxidants, preferably phenolic antioxidant, aliphatic process oils, process aids, pigments, dyes, tackifiers, waxes, reinforcing aids, UV stabilization agents, blowing agents, scorch protectors, activators, antiozonants or coagents may also be added to the composition as previously defined before, after and/or during the curing step.

According to one embodiment of the present invention, the method for manufacturing an article, preferably an elastomeric article, comprises curing a composition in the full or partial presence of oxygen; wherein said composition comprising:
a) at least one elastomer,
b) at least one organic peroxide,
c) at least one sulfur-containing compound chosen among the group consisting of dialkyl phosphorodithioic acid and salts thereof, in particular zinc dialkyl dithiophosphates,
d) optionally sulfur under its free form,
e) optionally at least one filler, which, when present, is in an amount of at least 10 phr,
wherein the organic peroxide is present at a concentration comprised between 0.1 phr to 20 phr,
wherein the sulfur-containing compound is present in the composition of the present invention at a concentration lower than 3.3 phr
wherein sulfur under its free form is present in an amount from 0 to 0.5 phr.

### Article

Another subject-matter of the present invention deals with an article comprising a composition as previously described in a cured form, preferably said article being completely or substantially tack-free.

Preferably, the article has a surface tackiness of between between 7 and 9.9 or preferably between 8 and 9.9 or 10, more preferably between 9 and 9.9 or 10.

An article that is completely tack-free has a surface tackiness of 10 and is most desirable.

A method for measuring surface tackiness is provided herein, and is referred to as the Facial Tissue Paper Test.

The article is preferably a non-coating type (i.e., not a liquid coating).

According to another aspect of the present invention, the article is manufactured according to the method as previously described.

The method may include dissolving high molecular weight solid polymers in a solvent, then removing the solvent to create a solid elastomer structure which is then hot air cured in a separate step (e.g., to provide a means to impregnate textiles). One example of this commercial use is the production of automotive air bags.

Additional examples include cured-in-place solid elastomer automotive and truck head gaskets, in which case a liquid solution of solvent and a high molecular weight polymer, or blends of polymers, along with curatives, is applied to a metal surface. The solvent is removed, leaving a solid high molecular weight polymer of complex structure on the metal part. This solid rubber gasket on the metal part can then be heated to crosslink the polymer. In each case, the solvent must be substantially or preferably completely removed from the solid polymer or elastomer; once the solid elastomer is free of solvent, the part can then be cured by applying heat to begin the crosslinking reaction. This is in contrast to paints, coatings and varnishes, wherein the cure process is concurrent with the solvent removal.

The article is preferably selected from the group consisting of a seal, hose or gasket.

The article is preferably manufactured according to the aforementioned method.

### Use

The invention is also directed to the use of a composition comprising:
a) at least one organic peroxide,
b) at least one sulfur-containing compound chosen among the group consisting of dialkyl phosphorodithioic acid and salts thereof, in particular zinc dialkyl dithiophosphates,
c) optionally sulfur under its free form,
d) at least one filler,
   wherein the weight ratio between said at least one organic peroxide and said at least one sulfur-containing compound is higher than 0.3, preferably higher than 0.5, more preferably higher than 0.8,
wherein the weight ratio between sulfur under its free form and said at least one organic peroxide is lower than 0.15, preferably lower than 0.1,
wherein the weight ratio between said at least one filler and said at least one organic peroxide is higher than 10,
in order to improve the mechanical properties, especially the tensile properties and compression set, of a composition comprising at least one elastomer.

Preferably, the composition is as defined above.

The enhanced tensile properties are preferably the tensile strength and/or the percentage of elongation at break.

Preferably, the elastomer is unsaturated.

Preferably, the elastomer corresponds to an ethylene-propylene-diene terpolymer (EPDM).

Another subject-matter of the present invention is the use of a composition comprising:
a) at least one elastomer,
b) at least one organic peroxide,
c) at least one sulfur-containing compound chosen among the group consisting of dialkyl phosphorodithioic acid and salts thereof, in particular zinc dialkyl dithiophosphates,
d) optionally sulfur under its free form,
e) at least one filler,
wherein the weight ratio between said at least one organic peroxide and said at least one sulfur-containing compound is higher than 0.3, preferably higher than 0.5, more preferably higher than 0.8,
wherein the weight ratio between sulfur under its free form and said at least one organic peroxide is lower than 0.15, preferably lower than 0.1,
wherein the weight ratio between said at least one filler and said at least one organic peroxide is higher than 10,
for the manufacture of an article, preferably an elastomeric article, even more preferably an article selected from the group consisting of a seal, hose or gasket.

According to one embodiment, a subject-matter of the present invention also relies on the use of a composition comprising:
a) at least one elastomer,
b) at least one organic peroxide,
c) at least one sulfur-containing compound chosen among the group consisting of dialkyl phosphorodithioic acid and salts thereof, in particular zinc dialkyl dithiophosphates,
d) optionally sulfur under its free form,
e) at least one filler,
wherein the organic peroxide is present at a concentration comprised between 0.1 phr to 20 phr,
wherein the sulfur-containing compound is present in the composition of the present invention at a concentration lower than 3.3 phr
wherein sulfur under its free form is present in an amount from 0 to 0.5 phr
wherein the filler is present in an amount of at least 10 phr,
for the manufacture of an article, preferably an elastomeric article, even more preferably selected from the group consisting of a seal, hose or gasket.

The following examples below are given as illustrations of the present invention.

### EXAMPLES

### Abbreviations Used for the RPA Rheometer Test

ML (dN-m) is the minimum torque in deci-Newton-meters in a RPA rheometer test and relates to the viscosity of the elastomer composition at the test temperature.

MH (dN-m) is the maximum torque in deci-Newton-meters in a RPA rheometer test and relates to the maximum amount of crosslinking attained.

MH-ML (dN-m) is the relative degree of crosslinking in deci-Newton-meters

Ts1 (min) is the time to attain a 1 dN-m increase from the minimum torque in minutes

Ts2 (min) is the time to attain a 2 dN-m increase from the minimum torque in minutes

Tc50 (min) is the time to attain 50% of the MH-ML (dN-m) cure state in minutes from the minimum torque.

Tc90 (min) is the time to attain 90% of the MH-ML (dN-m) cure state in minutes, from the minimum torque.

### Abbreviations Used in the Examples

Luperox® F is 1,3(4)-bis[1-(tert-butylperoxy)-1-methylethyl]benzene available from Arkema.

Vultac® 5 is t-amyl phenol disulfide polymer, an arylpolysulfide polymer/oligomer also referred to as a poly(t-amylphenol disulfide); available from Arkema.

MBTS is benzothiazyl disulfide, also called mercaptobenzothiazole disulfide, also called Altax® from R. T. Vanderbilt.

ZDDP is phosphorodithioic acid, OO-di-C1-14-alkyl esters, zinc salts.

ZDTP is phosphorodithioic acid, mixed O,O-bis(2-ethylhexyl and iso-Bu and iso-Pr) esters, zinc salts.

ZBOP is phosphorodithioic acid, mixed O,O-bis(2-ethylhexyl and iso-Bu) esters, zinc salts.

### Test and Procedure

### Procedure for Mixing Rubber and Rubber Sheet Preparation

The following procedure was used for mixing rubber and preparing the rubber sheet for hot air curing. A Brabender Plasti-Corder® with a 50 ml capacity bowl that is jacketed with the ability to run room temperature or heated oil was used. The mixer was equipped with removable sigma type blades. Using the specific gravity provided with the pre-compounded elastomer, small strips of rubber were slowly added to the bowl at a mixing speed of 20 to 25 rpm. The total amount of rubber added to the Brabender Plasti-Corder® bowl was equivalent to the weight needed to provide 48 ml of rubber volume so that there was sufficient volume to add the peroxide curatives to the rubber, as the mixer has a ˜50 ml volume capacity.

Out of this 48 ml of rubber, two small strips of rubber (equivalent to about 4 grams or no more than 5 ml) were held in reserve. All the rest of the rubber was slowly added to the bowl. Once all the rubber was added to the mixer and the rubber was flowing in the bowl, the mixer rpm was reduced to 15 rpm and the peroxide formulation for that experiment, which was pre-weighed in small Dixie® cups on a minimum of a three place balance for good accuracy, was slowly added to the mixing rubber. To make sure all of the residual peroxide was included in the mixing rubber, the two small reserve rubber strips were used to wipe the powder off the V-shaped metal portion of the mixer. This powder adhered to the rubber strip and the remaining two strips of rubber were introduced into the mixer.

The rpm was then increased back to 25 rpm for three minutes. After this time, the mixer speed was lowered to 10 rpm and the mixer head was unbolted and removed. Once the blades were no longer turning, the rubber around the blades was safely removed and placed on a sheet of Mylar® polyester. There was a small amount of rubber that was located at the head of the mixer blades within the inner hollow portion of the mixing chamber, which was removed last. The mixer head was re-assembled with the bolts and the mixer motor was started again at 20 rpm. The rubber which was removed last, which was trapped in the mixing chamber, was added first to the spinning blades, followed by the rubber that was taken off the blades. This provided for a more uniform mixing of elastomer. The rpm was then increased to 25 rpm and held there for 3 minutes. After this time, the mixer speed was set to 10 rpm and the mixer head unbolted and removed. Once removed, the mixer blade motion stopped and it was again safe to remove all of the rubber from the mixer's bowl and blades.

The warm rubber was then formed into a tight ball and placed between two Mylar® polyester sheets. This sandwich was placed in a warmed hydraulic powered Carver press where the press may be set to between room temperature and 60° C., depending upon the elastomer and the peroxide curatives being used. The ball of rubber was pressed flat between the two heavy Mylar® polyester sheets. Wearing nitrile gloves, the press was opened and the Mylar® polyester sheet sandwich containing the flattened rubber was removed. The top sheet was removed and the rubber was rolled into a tube. This was re-sandwiched and flattened again. The sheet was rolled again, but 90 degrees to the original roll direction, and flattened again. This was repeated a third time, and care was taken to flatten to an approximate thickness of ⅛ inch. The sandwich was placed on the bench top and covered with a metal sheet where the rubber was allowed to cool. It was then removed and stored in a tightly-sealed polyethylene bag. These sheets were then cut with scissors or using a sharp metal circle punch, to make small flat circle sheets of uncured rubber for the Rheometer cure evaluation, and square flat sheets for the hot air oven testing using the “Facial Tissue Paper Test” described below.

### Facial Tissue Paper Test

The following procedure was used to test the surface tack of the rubber sheet after curing in a hot air oven. This procedure is also referred to as a “Facial Tissue Paper Test” for surface tackiness of a rubber sheet cured in a hot air oven.

A flat sheet of uncured rubber was prepared with dimensions of ⅛″ thick by 2″ wide and 3″ long, and was hung carefully in a pre-heated hot air oven set to 205° C. for 15 minutes. The sheet was hung in the oven by metal clamps from a metal rack to expose all sides of the sheet to the hot air. After 15 minutes of cure, the rubber sheet was promptly removed and placed on an aluminum foil-covered piece of cardboard. It was covered immediately with a Kleenex® Facial Tissue and very firm pressure was immediately applied by hand to the entire rubber surface, followed by applying a 1800 gram weight for five minutes. After the rubber cooled to room temperature, the soft facial tissue paper was carefully removed to examine the rubber surface for any tissue paper fibers that may have adhered to the surface. If a great many tissue paper fibers adhere, this indicates a poor surface cure, or one that has a high amount of surface tackiness.

As used herein, the Surface Tackiness Number=(% of surface with no paper fibers÷10). The Surface Tackiness number can range from 10 to 0. A completely tack-free cured rubber surface with no tissue paper fibers has a rating of 10. A very poorly cured rubber surface that is completely covered in tissue paper fibers is rated a 0. If 90% of the surface has no tissue paper fibers attached, the rating is a 9, if 70% of the surface has no tissue paper fibers attached, the rating is a 7, etc.

### Rheometer Procedures

The following procedure was used for moving die rheometer and RPA (Rubber Process Analzer) evaluations. For the Alpha Technologies MDR rheometer, test method ASTM D5289-12 “Standard Test Method for Rubber Property—Vulcanization Using Rotorless Cure Meters” was used. Test method ASTM D6204 was used with either a 0.5 degree or 1.0 degree arc and 100 cpm frequency of oscillation at cure temperatures appropriate for the curative system, e.g., 185° C. for the examples below.

When conducting rheometer evaluations, approximately 5 to 6 grams of elastomer (depending upon the density of the final compound) were used to completely fill the upper and lower dies of the rheometer. The uncured rubber was cut from the pressed sheet formed by the procedure described above. The rubber was cut into small round discs about 1.25 inches in diameter and placed between two Dartek® sheets. This sandwich was then placed in the rheometer for testing following ASTM D5289.

Following ASTM D6601 for after cure dynamic testing, a test with the RPA using the stress relaxation feature of the instrument with a 3 degree arc applied strain was applied to gauge the crosslinked elastomer's ability to serve as a gasket or seal. This purpose was very similar to the percent compression test following standard NF ISO 815. The loss of the elastic modulus or S′ (dN-m) is followed versus time, for several minutes. The rate in loss of elastic modulus reflects the percent compression set performance. The lowest percent compression values for cured rubber samples will have the lowest loss in the elastic modulus or S′ (dN-m) over a one minute period at a test temperature of 185° C. or higher.

### % Compression Set Procedures

The following procedures were used for compression set evaluations. The standardized test methods for % compression set were NF ISO 815 and/or ASTM D395, which are suitable for Ambient and High Temperature application testing. Specifically, in Example 1, NF ISO 815 was used, wherein samples for the test were first cured at 190° C. to form a cylinder of 6.3±0.3 mm height and 13±0.5 mm diameter using a curing time of Tc90+8 minutes, then test pieces were placed in the NF ISO 815 device to compress 25% at 150° C. for 24 hours. After this time, samples were released and placed on a wooden board at ambient temperature for 30 minutes before being measured for change in height.

### Tensile Testing Procedures

The following procedures were used for tensile testing. Tensile properties were determined by following the standard NF ISO 37 and/or ASTM D412. First, sheets of 1.5 mm thick were cured under pressure in a pneumatic press. The conditions of curing were determined from the Tc90 (minute) 90% of cure time result for the compound when tested on the MDR or RPA rheometer at 190° C. The curing temperature was 190° C. and the curing time was Tc90+8 minutes. Then, dumbbells were cut from the 1.5 mm cured sheet using the appropriate die designated by NF ISO 37 and/or ASTM D412. Finally, tensile tests were performed on the dumbbells using an INSTRON® 5565 tensile machine. A speed of 200 mm/min was used.

### Example

The EDPM Masterbatch elastomer formulation in Table 1 and the sulfur vulcanization “control” formulation in Table 2 were prepared. Table 3 provides a summary of seven sample runs, which tested various cure systems in the EPDM masterbatch formulation.

TABLE 1
“EPDM MB” Masterbatch Formulation

| Ingredient | Phr |
|---|---|
| Vistalon ® 2504 EPDM | 100.0 |
| N550 Carbon Black | 100.0 |
| Primol ® 352 white process oil | 40.0 |
| PEG Polyethylene glycol | 3.0 |
| Stanguard ® TMQ Powder | 1.0 |
| (antioxidant) | |
| Total weight of the masterbatch | 244.0 |

TABLE 2
Sulfur vulcanization control formulation
Sulfur Vulcanization Control Formulation
used to Cure “EPDM MB” found in TABLE 1

| Masterbatch Ingredient | Parts |
|---|---|
| “EPDM MB” | 244.0 |

NOTE:
244 PARTS OF “EPDM MB” CONTAINS 100 PARTS OF RUBBER

| “Sulfur Control” Ingredients | PHR (Parts Per 100 Rubber) |
|---|---|
| Zinc Oxide | 5.00 |
| Stearic Acid | 1.00 |
| Sulfur (80%) | 3.10 |
| MBTS (75%) | 2.20 |
| MBT (80%) | 1.64 |
| TMTD (80%) | 0.31 |
| Total Sulfur Control = | 13.25 |

TABLE 3
Sulfur and Peroxide Formulation Testing of TABLE 1 EPDM Masterbatch

| Sample # | 1 | 2 | 3 | 4 | 5 | 6 | 7 |
|---|---|---|---|---|---|---|---|
| Parts of “EPDM MB” | 244 | 244 | 244 | 244 | 244 | 244 | 244 |
| from Table 1 | | | | | | | |
| phr “Sulfur Control” | 13.25 | — | — | — | | | |
| from Table 2 | | | | | | | |
| phr Luperox ® F | — | 3.2 | 2.1 | 4.8 | 3.2 | 3.2 | 3.2 |
| phr Vultac ® 5 | — | — | 2.16 | 2.16 | | | |
| phr MBTS | — | — | 0.56 | 0.56 | | | |
| phr ZDDP (Cas Nr. | | | | | 1.0 (0.179 | | |
| 68649-42-3, | | | | | phr | | |
| supplier:ARCHOS) | | | | | equivalent | | |
| | | | | | S) | | |
| phr ZDTP | | | | | | 1.7 | |
| (Cas Nr. 85940-28-9, | | | | | | (0.179 phr | |
| Commercial Name: | | | | | | equivalent | |
| MIXLAND + ZDTP | | | | | | S) | |
| 50 GA | | | | | | | |
| Supplier:ARCHOS) | | | | | | | |
| phr ZBOP | | | | | | | 1.05 |
| (Cas Nr. 68442-22-8, | | | | | | | (0.179 phr |
| Commercial Name: | | | | | | | equivalent |
| LUBIO AW1 | | | | | | | S) |
| Supplier:Schäfer | | | | | | | |
| GmbH) | | | | | | | |

Moving Die Rheometer at 180° C., 1.677 Hz (100 cpm), 0.5° arc

| | | | | | | | |
|---|---|---|---|---|---|---|---|
| Crosslink Density | 27.5 | 27.5 | 15.7 | 28 | 23.1 | 21.1 | 21.4 |
| (MH − ML) | | | | | | | |
| in dN-m | | | | | | | |
| Curing time (T₉₀) in | 04:58 | 03:31 | 04:18 | 03:29 | 02:53 | 02:54 | 02:41 |
| min:sec | | | | | | | |
| Scorch time (Ts02) in | 00:44 | 00:23 | 00:41 | 00:27 | 00:27 | 00:26 | 00:30 |
| min:sec | | | | | | | |

Hot Air Cure at 205° C. for 15 minutes

| | | | | | | | |
|---|---|---|---|---|---|---|---|
| Surface Tack: 10 = | 10 | 2.8 | 9.3 | 9.8 | 9.5 | 9.5 | 9.5 |
| NO tack; 0 = 100% | | | | | | | |
| sticky | | | | | | | |

Physical Testing of Cured Elastomer

| | | | | | | | |
|---|---|---|---|---|---|---|---|
| Tensile Strength at | 18 | 16.1 | 12.7 | 16.5 | 20.4 | 21.1 | 21.7 |
| Break (MPa) | | | | | | | |
| % Elongation at Break | 229 | 169 | 312 | 207 | 216 | 244 | 266 |
| % Compression Set at | 93 | 24 | 76 | 31 | 30 | 23 | 20 |
| 150° C. for 24 hours | | | | | | | |

Sample #1 used the sulfur vulcanization “control” formulation described in Table 2. When 13.25 phr of total curative was utilized, no surface tackiness was observed (rating of 10 out of 10) after curing the elastomer in a hot air oven at 205° C. for 15 minutes. However, a very poor % compression set of 93% was observed. A 100% compression set represents a total and complete deformation under heat and stress, so a 93% value is nearly a complete failure for a sealing application, and reveals the poor heat-aging nature when such resins are subjected to sulfur vulcanization.

Sample #2 used a conventional organic peroxide Luperox® F. at 3.2 phr as the cure system in the EPDM masterbatch. The EPDM masterbatch cured with this standard peroxide exhibited considerable surface tackiness with a very poor rating of 2.8 out of a possible 10, after the 205° C. and 15 minute hot air oven cure process, and an excellent % compression set value of 24%. In addition, sample #2 shows a lower % elongation at break and tensile strength at break than sample #1.

Sample #3 used an organic peroxide formulation containing organic sulfide compounds, in particular a mixture of poly(t-amylphenol disulfide) and benzothiazyl disulfide. Sample #3 exhibits a better surface tackiness than sample #2 as it is graded 9.3 out of 10 but a lower tensile strength at break and a higher % compression set as its value soars. As a result, sample #3 shows poor mechanical properties.

Sample #4 also used an organic peroxide formulation containing an organic peroxide at higher concentration than sample #3 and the same mixture of organic sulfide compounds, that is to say benzothiazyl disulfide and poly(t-amylphenol disulfide). The result substantiates that sample #4 also displays a better surface tackiness than sample #2 as its value is graded 9.8 out 10 and a slightly better tensile strength at break and % elongation at break. However, the tensile properties of sample #4 are still outstripped by the tensile properties of sample #1.

Sample #5 is a formulation according to the present invention containing an organic peroxide Luperox® F., zinc dialkyl dithiophosphate type ZDDP at 0.179 phr of equivalent sulfur and no free sulfur. This sample shows a low surface tackiness, even slighter lower than the one measured for sample #3, and a lower % compression set than the one measured for sample #1 and #3. In addition, its tensile properties outperformed the tensile properties of sample #2 as it exhibits a higher tensile strength at break together with a better % elongation at break. It bespeaks sample #5 displays overall a better set of mechanical properties than samples #1-4. On top of that, the curing time of the formulation used in sample #5 is shorter than the ones of samples #1-4.

Sample #6 is also a formulation according to the present invention containing an organic peroxide Luperox® F., zinc dialkyl dithiophosphate type ZDTP at 0.179 phr of equivalent sulfur and no free sulfur. This sample shows a low surface tackiness, even slighter lower than the one measured for sample #3, and a lower % compression set than the one measured for samples #1 to #3. Besides, the tensile properties outperformed the tensile properties of samples #1 and #2 as it exhibits a higher tensile strength at break together with a better % elongation at break.

Sample #7 is also a formulation according to the present invention containing an organic peroxide Luperox® F., zinc dialkyl dithiophosphate type ZBOP at 0.179 of equivalent sulfur phr and no free sulfur. This sample shows a low surface tackiness, even slighter lower than the one measured for sample #3, and a lower % compression set than the one measured for samples #1 to #3. In particular, the % compression set is significantly than the one of sample #2. Besides, the tensile properties outperformed the tensile properties of samples #1 and #2 as it exhibits a higher tensile strength at break together with a better % elongation at break. Hence the results flesh out the fact that the formulation of the present invention leads to better physical properties, in particular mechanical properties than the formulation used to yield samples #1 and 2. On top of that, the curing time has even been reduced.

1-16. (canceled)

17. Composition comprising:
a) at least one organic peroxide,
b) at least one sulfur-containing compound selected from the group consisting of dialkyl phosphorodithioic acid and salts thereof,
c) optionally sulfur under its free form,
d) at least one filler,
wherein the weight ratio between said at least one organic peroxide and said at least one sulfur-containing compound is higher than 0.3,
wherein the weight ratio between sulfur under its free form and said at least one organic peroxide is lower than 0.15,
wherein the weight ratio between said at least one filler and said at least one organic peroxide is higher than 10.

18. Composition according to claim 17, characterized in that the organic peroxide is selected from the group consisting of 1,3(4)-bis[1-(tert-butylperoxy)-1-methylethyl]benzene, 1,1-di(t-butylperoxy)-3,3,5-trimethylcyclohexane, t-butylperoxybenzoate, t-butyl-2-ethylhexylmonoperoxycarbonate, 2,5-dimethyl-2,5-di(t-butylperoxy)hexane, dicumyl peroxide, and t-butylcumylperoxide, and mixtures thereof.

19. Composition according to claim 17, characterized in that dialkyl dithiophosphates salts have the following formula (VI): 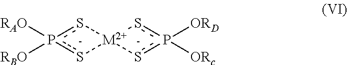
wherein R_{A}, R_{B}, R_{C} and R_{D}, identical or different, represent:
a linear or branched C₁-C₃₀ alkyl radical,
a cyclic alkyl group comprising from 4 to 30 carbon atoms,
M²⁺ is a divalent metal.

20. Composition according to claim 17, characterized in that said filler is selected from the group consisting of water washed clay, black carbon, calcium carbonate, silica, precipitated silica, calcium silicate, kaolin, liquid saturated hydrocarbon, and combination thereof.

21. Composition according to claim 17, characterized in that said composition further comprises at least one elastomer.

22. Composition according to claim 21, characterized in that said elastomer is saturated and selected from the group consisting of silicon rubber without unsaturation (Q), methyl-polysiloxane (MQ), phenyl-methyl-polysiloxane (PMQ), poly(ethylene-vinyl acetate) (EVA), high-density polyethylene (HDPE), low-density polyethylene (LDPE), chlorinated poly(ethylene) (CM or CPE), poly(ethylene-propylene) (EPM), fluoroelastomers (FKM, FFKM) and combinations thereof.

23. Composition according to claim 21, characterized in that said elastomer is unsaturated and selected from the group consisting of ethylene-propylene-diene terpolymer (EPDM), vinyl silicone rubber (VMQ), fluorosilicone (FVMQ), nitrile rubber (NBR), acrylonitrile-butadiene-styrene (ABS), styrene butadiene rubber (SBR), styrene-butadiene-styrene block copolymers (SBS), polybutadiene rubber (BR), styrene-isoprene-styrene block copolymers (SIS), partially hydrogenated acrylonitrile butadiene (HNBR), natural rubber (NR), synthetic polyisoprene rubber (IR), neoprene rubber (CR), polychloropropene, bromobutyl rubber (BIIR), chlorobutyl rubber, and mixtures thereof.

24. Composition according to claim 21, characterized in that said at least one sulfur-containing compound is present in an amount lower than 3.3 phr.

21. Composition according to claim 21, characterized in that said sulfur under its free form is present in an amount ranging from 0 to 0.5 phr.

26. Composition according to claim 17, characterized in that said composition further comprises at least one HALS compound.

27. Composition according to claim 17, characterized in that said composition further comprises at least one antioxidant.

28. Method for manufacturing an article comprising a step of curing a composition in the full or partial presence of oxygen, said composition comprising:
a) at least one elastomer,
b) at least one organic peroxide,
c) at least one sulfur-containing compound selected from the group consisting of dialkyl phosphorodithioic acid and salts thereof,
d) optionally sulfur under its free form,
wherein the weight ratio between said at least one organic peroxide and said at least one sulfur-containing compound is higher than 0.3,
wherein the weight ratio between sulfur under its free form and said at least one organic peroxide is lower than 0.15.

29. Article comprising a composition as defined according to claim 21 in a cured form.

28. Article manufactured according to the method defined in claim 28.

31. Article according to claim 29, characterized in that it is selected from the group consisting of a seal, hose and gasket.

32. A composition according to claim 19, wherein M²⁺ is selected from the group consisting of zinc, calcium, and copper, and R_{A}, R_{B}, R_{C} and R_{D} are identical and represent a linear C₁-C₄ alkyl radical.

33. A composition according to claim 26, wherein the at least one HALS compound is selected from the group consisting of poly[[6-[(1,1,3,3-tetramethylbutyl)amino]-s-triazine-2,4-diyl]-[(2,2,6,6-tetramethyl-4-piperidyl)imino]-hexamethylene-[(2,2,6,6-tetramethyl-4-piperidyl)imino]], [bis(2,2,6,6-tetramethyl-4-piperidinyl)sebacate], and mixtures thereof.
